(19) United States
(12) Patent Application Publication
(10) Pub. No.: US 2026/0292112 A1
(43) Pub. Date: Sep. 24, 2026

(54) PROJECTION DEVICE AND DISPLAY SYSTEM

(71) Applicants: BEIJING BOE DISPLAY TECHNOLOGY CO., LTD., Beijing (CN); BOE TECHNOLOGY GROUP CO., LTD., Beijing (CN); Beijing BOE Technology Development Co., Ltd., Beijing (CN)

(72) Inventors: Zipei Xu, Beijing (CN); Wei Zhang, Beijing (CN); Xi Li, Beijing (CN); Jiaqiang Wang, Beijing (CN); Weichao Zhang, Beijing (CN)

(73) Assignees: BEIJING BOE DISPLAY TECHNOLOGY CO., LTD., Beijing (CN); BOE TECHNOLOGY GROUP CO., LTD., Beijing (CN); Beijing BOE Technology Development Co., Ltd., Beijing (CN)

(21) Appl. No.: 19/478,017

(22) PCT Filed: May 29, 2024
(86) PCT No.: PCT/CN2024/095952

§ 371 Date: Oct. 23, 2025

(30) Foreign Application Priority Data
May 31, 2023 (CN) 202310639443.4

(51) Int. Cl. H04N 9/31; G03B 21/00; G03B 21/20

(52) U.S. Cl. CPC H04N 9/317; G03B 21/006; G03B 21/2066; G03B 21/208; H04N 9/3102; H04N 9/3152

(57) ABSTRACT

A projection device and a display system are provided. The projection device includes a light source assembly, a light converging assembly, a display panel and a lens assembly. A surface of the light converging assembly includes a plurality of unit regions, and the plurality of unit regions does not go beyond a region of X*Y, where X and Y are both positive integers; a reflective thin film covers the plurality of unit regions at the surface of the light converging assembly; a reflectivity of the reflective thin film corresponding to at least one unit region in the plurality of unit regions is different from a reflectivity of the reflective thin film corresponding to the remaining unit regions; and light reflected by different unit regions of the light converging assembly enters different unit display regions at a display region of the display panel.

### CROSS-REFERENCE TO RELATED APPLICATION

This application claims a priority of the Chinese patent application No. 202310639443.4 filed on May 31, 2023, which is incorporated herein by reference in its entirety.

### TECHNICAL FIELD

The present disclosure relates to the field of projection technology, in particular to a projection device and a display system.

### BACKGROUND

A projection device is a device for projecting an image or video onto a screen, and it is coupled to such a device as computer, game machine or television through different interfaces, so as to play a corresponding video signal. The projection device is widely applied to home, offices, schools and entertainment venues.

Currently, the market-available projection devices mainly include a Cathode Ray Tube (CRT) projection device, a Liquid Crysal Display (LCD) projection device, and a Digital Light Processing (DLP) projection device. The LCD projection device mainly includes a single-LCD projection device, a triple-LCD projection device, etc. The single-LCD projection device has a simple structure and low manufacture cost, and it is suitable for middle and low-income consumers, so it has a considerable growth potential.

The existing single-LCD projection device has high brightness at a center and low brightness at an edge, so the uniformity of an actual projection image is insufficient.

### SUMMARY

In a first aspect, the present disclosure provides in some embodiments a projection device, including a light source assembly, a light converging assembly, a display panel and a lens assembly. Light emitted by the light source assembly passes through the light converging assembly, the display panel and the lens assembly sequentially; a surface of the light converging assembly includes a plurality of unit regions, and the plurality of unit regions does not go beyond a region of X*Y, where X and Y are both positive integers; a reflective thin film covers the plurality of unit regions at the surface of the light converging assembly; a reflectivity of the reflective thin film corresponding to at least one unit region in the plurality of unit regions is different from a reflectivity of the reflective thin film corresponding to the remaining unit regions; and light reflected by different unit regions of the light converging assembly enters different unit display regions at a display region of the display panel.

In an embodiment of the present disclosure, the surface of the light converging assembly includes a central region and a peripheral region, and the central region includes M*N unit regions, where M is a positive integer smaller than X, and N is a positive integer smaller than Y; the peripheral region includes at least one unit region; and the reflectivity of the reflective thin film at the central region is smaller than the reflectivity of the reflective thin film at the peripheral region.

In an embodiment of the present disclosure, the light reflected by the central region of the light converging assembly enters a central region of the display panel, and the light reflected by the peripheral region of the surface of the light converging assembly enters a peripheral region of the display panel.

In an embodiment of the present disclosure, the light converging assembly includes a reflection cup; the light source assembly is arranged at an inlet of the reflection cup, and the display panel is arranged at an outlet of the reflection cup; in a direction parallel to the display panel, a size of the outlet of the reflection cup is greater than a size of the inlet of the reflection cup; and the surface of the light converging assembly includes an inner wall of the reflection cup.

In an embodiment of the present disclosure, the light converging assembly includes a planoconvex lens and a first reflector; the light source assembly is arranged at a side of a flat surface of the planoconvex lens, the first reflector is arranged at a convex surface of the planoconvex lens, a central axis of the planoconvex lens is parallel to an incident optical path of the first reflector, and an emergent optical path of the first reflector is perpendicular to the display panel; and the surface of the light converging assembly includes a surface of the first reflector.

In an embodiment of the present disclosure, in a cross section perpendicular to the display panel, the first reflector is of a trapezoidal shape.

In an embodiment of the present disclosure, the reflectivity of the reflective thin film corresponding to four corner regions in a peripheral region of the first reflector is smaller than the reflectivity of the reflective thin film corresponding to a central region of the first reflector and regions other than the four corner regions in the peripheral region.

In an embodiment of the present disclosure, the projection device further includes a first lens, and the first lens is arranged between the light converging assembly and the display panel; and light from the light converging assembly is modulated by the first lens into approximately collimated light, and enters the display panel.

In an embodiment of the present disclosure, the projection device further includes a second lens, and the second lens is arranged at a side of the display panel away from the first lens; and the second lens and the display panel are embedded at two opposite sides of a projection device fixation frame respectively.

In an embodiment of the present disclosure, the projection device further includes a second reflector; the second reflector is arranged at a side of the second lens away from the display panel, a central axis of the second lens is parallel to an incident optical path of the second reflector, and an emergent optical path of the second reflector is parallel to an optical axis of the lens assembly; and the second reflector is detachably mounted on a housing of the projection device.

In a second aspect, the present disclosure provides in some embodiments a display system, including: the above-mentioned projection device; and a projection screen configured to receive light from the lens assembly of the projection device to form a projection image.

### BRIEF DESCRIPTION OF THE DRAWINGS

The above and/or additional aspects and advantages of the present disclosure will become apparent and comprehensible in conjunction with the drawings, and in these drawings:

FIG. 1 is a schematic view showing a projection device according to an embodiment of the present disclosure;

FIG. 2 is an exploded view of a display panel, a second lens and a fixation frame of the projection device according to an embodiment of the present disclosure;

FIG. 3 is a right view of a situation where the display panel cooperates with a groove in an inner surface of a housing in the projection device in FIG. 1 in a simplified manner (i.e., the irrelevant structures are omitted);

FIG. 4 is a schematic view showing an optical path of the projection device in FIG. 1 in a simplified manner (i.e., the structures irrelevant to the optical path are omitted);

FIG. 5 is another schematic view showing the optical path of the projection device in a simplified manner (i.e., the structures irrelevant to the optical path are omitted) according to an embodiment of the present disclosure;

FIG. 6 is a schematic view showing a distribution proportion at a surface of a first reflector in FIG. 4; and

FIG. 7 is a schematic view showing a reflective thin film with two reflectivities covering the surface of the first reflector in the projection device according to an embodiment of the present disclosure.

### REFERENCE SIGN LIST

1 housing
11 inner surface
111 groove
2 light source assembly
21 light-emitting element
22 base
3 lens assembly
41 first heat dissipator
42 second heat dissipator
51 first fan
52 second fan
61 first lens
62 transparent member
63 second lens
64 display panel
65 second reflector
71 first aperture
72 second aperture
73 third aperture
74 cavity
8 light converging assembly
81 planoconvex lens
82 first reflector
83 reflection cup
9 fixation frame
91 pass-through side
92 positioning side
921 ridge
93 U-shape clip
931 matched ridge
10 base plate
101 support surface
102 support leg
103 carrier structure

### DETAILED DESCRIPTION

The present disclosure will be described hereinafter in conjunction with the drawings. It should be appreciated that, the embodiments described in conjunction with the drawings are used to illustratively describe the technical solutions of the present disclosure, but shall not be construed as limiting the technical solutions of the present disclosure.

It should be appreciated that, unless otherwise defined, such words as “one” or “one of” are merely used to represent the existence of at least one member, rather than to limit the number thereof. Such words as “include” or “including” intend to indicate that there are the features, integers, steps, operations, elements and/or assemblies, without excluding the existence or addition of one or more other features, information, data, steps, operations, elements, assemblies and/or combinations thereof. In addition, the expression “and/or” is merely used to represent at least one of listed objects. For example, “A and/or B” may represent that, there is only A, there are both A and B, and there is only B.

In order to make the objects, the technical solutions and the advantages of the present disclosure more apparent, the present disclosure will be described hereinafter in conjunction with the drawings and embodiments.

At first, the relevant technologies involved in the present disclosure will be described.

It is found through researches that, the existing single-LCD projection device has high brightness at a center and low brightness at an edge, so the uniformity of an actual projection image is insufficient.

The technical solutions of the present disclosure and how to solve the above technical problem using the technical solutions of the present disclosure will be described hereinafter in conjunction with the specific embodiments. It should be appreciated that, cross reference may be made among the following embodiments, or the following embodiments may be combined. Identical terms, similar features and similar steps in different embodiments will not be repeated.

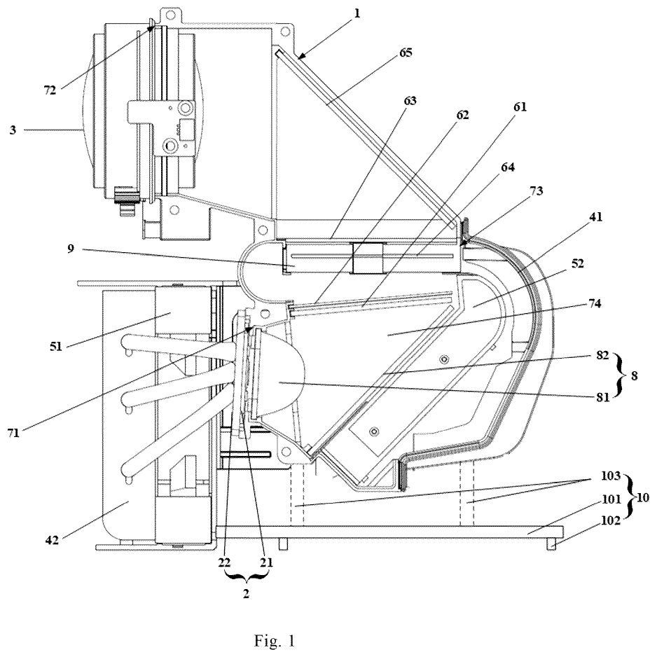

The present disclosure provides in some embodiments a projection device which, as shown in FIGS. 1 and 4-7, includes a light source assembly 2, a light converging assembly 8, a display panel 64 and a lens assembly 3.

Light emitted by the light source assembly 2 passes through the light converging assembly 8, the display panel 64 and the lens assembly 3 sequentially.

A surface of the light converging assembly 8 includes a plurality of unit regions, and the plurality of unit regions does not go beyond a region of X*Y, where X and Y are both positive integers. A reflective thin film covers the plurality of unit regions at the surface of the light converging assembly 8. A reflectivity of the reflective thin film corresponding to at least one unit region in the plurality of unit regions is different from a reflectivity of the reflective thin film corresponding to the remaining unit regions.

Light reflected by different unit regions of the light converging assembly 8 enters different unit display regions at a display region of the display panel 64.

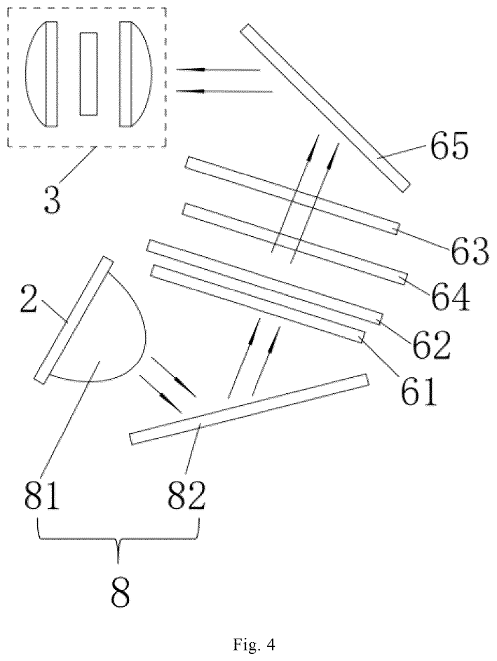

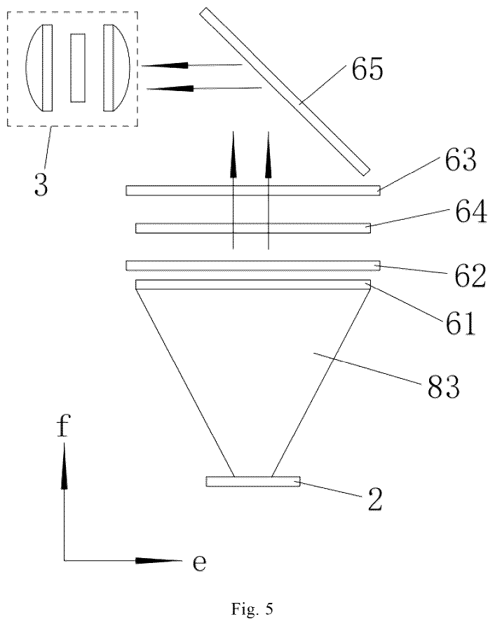

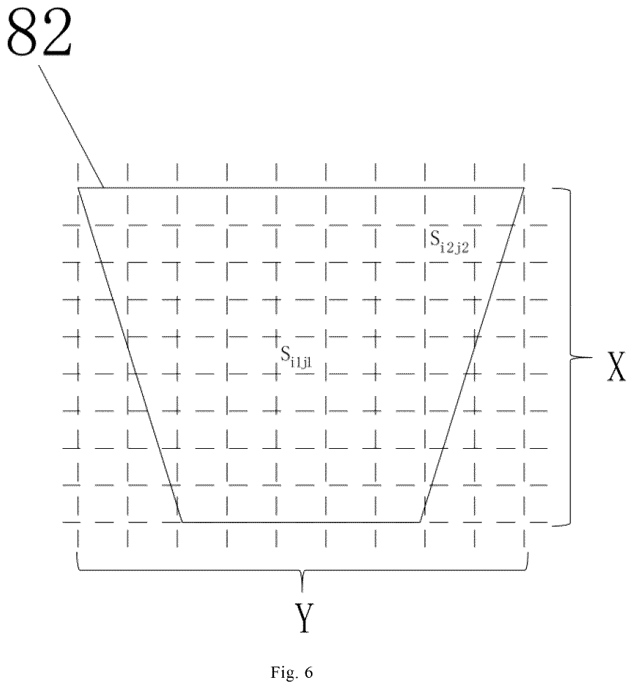

Optionally, the light converging assembly 8 in the embodiments of the present disclosure includes a surface of a first reflector 82 in FIG. 4 or an inner wall of a reflection cup 83 in FIG. 5. The following description about the surface of the light converging assembly will be given by taking the first reflector 82 as an example. As shown in FIG. 6, in a case that the plurality of unit regions at the surface of the light converging assembly 8 does not go beyond the region of X*Y, it means that the plurality of unit regions at the surface of the light converging assembly 8 is included in a region including X rows and Y columns.

In the projection device provided in the embodiments of the present disclosure, the reflective thin film covers the plurality of unit regions at the surface of the light converging assembly 8, and the light emitted by the light source assembly 2 passes through the light converging assembly 8, the display panel 64 and the lens assembly 3 sequentially. The light reflected by different unit regions of the light converging assembly 8 enters different unit display regions at the display region of the display panel 64. The reflectivity of the reflective thin film corresponding to different unit regions at the surface of the light converging assembly 8 is adjusted, so that the light reflected by different unit regions of the light converging assembly 8 has approximately same luminance. As a result, the light entering different unit display regions of the display panel 64 has approximately same brightness, so as to improve the uniformity of an entire image.

Optionally, in an embodiment of the present disclosure, as shown in FIGS. 4-6, the surface of the light converging assembly 8 includes a central region and a peripheral region, and the central region includes M*N unit regions, where M is a positive integer smaller than X, and N is a positive integer smaller than Y; the peripheral region includes at least one unit region; and the reflectivity of the reflective thin film at the central region of the surface of the light converging assembly 8 is smaller than the reflectivity of the reflective thin film at the peripheral region.

Optionally, in an embodiment of the present disclosure, the surface of the light converging assembly 8 is divided into the central region and the peripheral region, the central region includes M*N unit regions, and the peripheral region includes the remaining unit regions other than the central region. The reflectivity of the reflective thin film corresponding to the M*N unit regions at the central region of the light converging assembly 8 is smaller than the reflectivity of the reflective thin film corresponding to the peripheral region of the light converging assembly 8, so as to enable the luminance of the light reflected by the central region to be close to the luminance of the light reflected by the peripheral region, thereby to improve the uniformity of the entire image.

Optionally, in an embodiment of the present disclosure, as shown in FIGS. 4-6, the light reflected by the central region of the light converging assembly 8 enters a central region of the display panel 64, and the light reflected by the peripheral region of the surface of the light converging assembly 8 enters a peripheral region of the display panel 64.

Optionally, in an embodiment of the present disclosure, the light reflected by the central region of the light converging assembly 8 enters the central region of the display panel 64, and the light reflected by the peripheral region of the surface of the light converging assembly 8 enters the peripheral region of the display panel 64. Through adjusting the reflectivity of the reflective thin film corresponding to the central region at the surface of the light converging assembly 8 and the reflectivity of the reflective thin film corresponding to the peripheral region at the surface of the light converging assembly 8, the luminance of the light reflected by the central region at the surface of the light converging assembly 8 is close to the luminance of the light reflected by the peripheral region at the surface of the light converging assembly 8. In this way, the light entering different unit display regions of the display panel 64 have approximately same brightness, so as to improve the uniformity of the entire image.

Optionally, in an embodiment of the present disclosure, as shown in FIG. 5, the light converging assembly 8 includes a reflection cup 83.

The light source assembly 2 is arranged at an inlet of the reflection cup 83, the display panel 64 is arranged at an outlet of the reflection cup 83, and in a direction e parallel to the display panel 64, a size of the outlet of the reflection cup 83 is greater than a size of the inlet of the reflection cup 83.

The surface of the light converging assembly 8 includes an inner wall of the reflection cup 83.

Optionally, in an embodiment of the present disclosure, as shown in FIG. 5, the direction e is a direction parallel to the display panel 64, and a direction f is a direction perpendicular to the display panel 64. The light emitted by the light source assembly 2 enters the reflection cup 83 through the inlet of the reflection cup 83, is reflected by the inner wall of the reflection cup 83, and then is propagated toward the display panel 64 through the outlet of the reflection cup 83. An image generated by the display panel 64 is projected by the lens assembly 3 toward to a screen to form a projection image.

Optionally, in an embodiment of the present disclosure, in the direction parallel to the display panel 64, a size of the reflection cup 83 at a side close to the display panel 64 is greater than a size of the reflection cup 83 at a side close to the light source assembly 2, i.e., the size of the outlet of the reflection cup 83 is greater than the size of the inlet of the reflection cup 83.

Optionally, in an embodiment of the present disclosure, the inner wall of the reflection cup 83 includes a plurality of unit regions, and the plurality of unit regions does not go beyond the region of X*Y. The reflective thin film covers the inner wall of the reflection cup 83. In a specific embodiment of the present disclosure, the plurality of unit regions at the inner wall of the reflection cup 83 is divided into a central region and a peripheral region, and the central region includes M*N unit regions, where M is a positive integer smaller than X, and N is a positive integer smaller than Y. The peripheral region includes at least one unit region. Light reflected by the central region at the inner wall of the reflection cup 83 enters the central region of the display panel 64, and light reflected by the peripheral region at the inner wall of the reflection cup 83 enters the peripheral region of the display panel. Through adjusting the reflectivity of the reflective thin film corresponding to the inner wall of the reflection cup 83 and the reflectivity of the reflective thin film corresponding to the peripheral region at the inner wall of the reflection cup 83, luminance of the light reflected by the central region at the inner wall of the reflection cup 83 is close to luminance of the light reflected by the peripheral region at the inner wall of the reflection cup 83, so as to enable the light entering different unit display regions of the display panel 64 to have approximately same brightness, thereby to improve the uniformity of the entire image.

Optionally, in an embodiment of the present disclosure, as shown in FIGS. 4, 6 and 7, the light converging assembly 8 includes a planoconvex lens 81 and a first reflector 82; the light source assembly 2 is arranged at a side of a flat surface of the planoconvex lens 81, the first reflector 82 is arranged at a convex surface of the planoconvex lens 81, a central axis of the planoconvex lens 81 is parallel to an incident optical path of the first reflector 82, and an emergent optical path of the first reflector 82 is perpendicular to the display panel 64; and the surface of the light converging assembly 8 includes a surface of the first reflector 82.

Optionally, in an embodiment of the present disclosure, the light emitted by the light source assembly 2 enters the planoconvex lens 81 through the flat surface of the planoconvex lens 81, is refracted by the convex surface of the planoconvex lens 81, and is then reflected by the first reflector 82 toward the display panel 64. An image generated by the display panel 64 is projected through the lens assembly 3 to a screen several meters away to form a projection image. The first reflector 82 is arranged at a side of the convex surface of the planoconvex lens 81, the central axis of the planoconvex lens 81 is parallel to the incident optical path of the first reflector 82, and the emergent optical path of the first reflector 82 is perpendicular to the display panel 64.

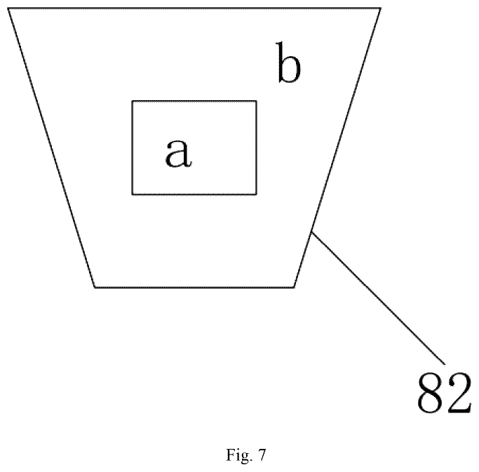

Optionally, in an embodiment of the present disclosure, as shown in FIG. 6, a surface of the first reflector 82 includes a plurality of unit regions, and the plurality of unit regions does not go beyond the region of X*Y. The reflective thin film covers the plurality of unit regions at the surface of the first reflector 82. Sᵢ₁ⱼ₁ and Sᵢ₂ⱼ₂ represent two unit regions at the surface of the first reflector 82, where i1 and i2 represent serial numbers of rows of the unit regions, j1 and j2 represent serial numbers of columns of the unit regions, i1 and i2 are not greater than X, and j1 and j2 are not greater than Y. In a specific embodiment of the present disclosure, as shown in FIGS. 6 and 7, the plurality of unit regions at the surface of the first reflector 82 is divided into a central region a and a peripheral region b, the unit region Sᵢ₁ⱼ₁ is located in the central region a, and the unit region Sᵢ₂ⱼ₂ is located in the peripheral region b. Light reflected by the central region a at the surface of the first reflector 82 enters the central region of the display panel 64, and light reflected by the peripheral region b at the surface of the first reflector 82 enters the peripheral region of the display panel 64. Through adjusting the reflectivity of the reflective thin film corresponding to the central region a at the surface of the first reflector 82 and the reflectivity of the reflective thin film corresponding to the peripheral region b at the surface of the first reflector 82, luminance of the light reflected by the central region a at the surface of the first reflector 82 is close to luminance of the light reflected by the peripheral region b at the surface of the first reflector 82, so as to enable the light entering different unit display regions of the display panel 64 to have approximately same brightness, thereby to improve the uniformity of the entire image.

Optionally, in an embodiment of the present disclosure, there mainly exist two types of light converging assemblies 8 of the projection device, i.e., the reflection cup 83, and a combination of the planoconvex lens 81 and the first reflector 82. Except the two types of light converging assemblies 8, the other components in the projection device have a substantially same structure. The structure of the projection device will be described hereinafter in a case that the light converging assembly 8 includes the planoconvex lens 81 and the first reflector 82.

In order to describe the structure of the projection device conveniently, a side of the projection device facing the projection image is a front side, a rear side is a side of the projection device away from the projection image, and a left-to-right direction is perpendicular to a front-to-rear direction. An upper-to-lower direction is perpendicular to the front-to-rear direction and the left-to-right direction. As shown in FIG. 1, the lens assembly 3 is located in front of the first reflector 112 and above a first fan 51.

As shown in FIG. 1, the projection device includes a housing 1. The housing 1 includes a front surface and a rear surface opposite to each other, the front surface includes a first aperture 71 and a second aperture 72, and at least a portion of a third aperture 73 is arranged at the rear surface.

The light source assembly 2 includes a light-emitting element 21 and a base 22. The light-emitting element 21 is arranged on the base 22 and at the first aperture 71. The lens assembly 3 is arranged at the second aperture 72. A first heat dissipator 41 is arranged at the third aperture 73. The light source assembly 2, the lens assembly 3, the first heat dissipator 4 and the housing 1 together form a hermetically sealed cavity 74. The cavity 74 defines a hermetically sealed space, so as to prevent dust from entering the housing 1, thereby to ensure the cleanness of an optical member.

The first fan 51 is arranged at a side of the light source assembly 2 away from the cavity 74, and a second heat dissipator 42 is arranged at a side of the first fan 51 away from the light source assembly 2.

The projection device further includes a base plate 10. The base plate 10 is arranged opposite to a portion of the first heat dissipator 41. The base plate 10 includes a support surface 101, a support leg 102 and a carrier structure 103, the support leg 102 is in direct contact with a surface where the projection device is placed, the support surface 101 is arranged at a side of the support leg 102 away from the surface where the projection device is placed, and the carrier structure 103 is arranged at a side of the support surface 101 away from the support leg 102 to support the housing 1.

Optionally, in an embodiment of the present disclosure, a gas-tight filler is arranged between the second aperture 72 and the lens assembly 3, so as to improve the sealing performance of the cavity 74. The housing 1 refers to a shell structure of the projection device.

Optionally, in an embodiment of the present disclosure, as shown in FIG. 1, the first heat dissipator 41 is of an arch-like shape, and a main heat dissipation region inside of the projection device is fully enclosed by the first heat dissipator 41, so as to achieve the heat exchange completely, and improve the heat dissipation efficiency. The first heat dissipator 4 includes a cast-aluminum heat dissipator.

Optionally, in an embodiment of the present disclosure, in an operating state of the projection device, the lens assembly 3 is located at a level higher than the light source assembly 2. The housing 1 further includes a bottom surface and a top surface, the bottom surface is located at a level lower than the top surface, and the front surface and the rear surface are coupled to the top surface and the bottom surface respectively.

Optionally, in an embodiment of the present disclosure, the projection device further includes a second fan 52 in the cavity 74 and configured to push air in the cavity 74 to circulate. The heat exchange is performed between hot air in the cavity and external cold air through the first heat dissipator 41.

Optionally, in an embodiment of the present disclosure, as shown in FIG. 1, the planoconvex lens 81 is arranged at a light-exiting side of the light source assembly 2, and configured to converge the light emitted by the light source assembly 21, so as to bright the light together or shape the light, and ensure the utilization rate of the light emitted by the light-emitting element 21, thereby to reduce the power consumption. The first reflector 82 is obliquely arranged at a side of the second fan 52 away from the first heat dissipator 51. A convex surface of the planoconvex lens 81 faces the first reflector 82. The first reflector 82 is arranged in the cavity 74 and mounted onto the housing 1 in a snap-fit manner.

Optionally, in an embodiment of the present disclosure, as shown in FIGS. 6 and 7, in a cross section perpendicular to the display panel 64, the first reflector 82 is of a trapezoidal shape.

Optionally, in an embodiment of the present disclosure, the cross section perpendicular to the display panel 64, the first reflector 82 is of the trapezoidal shape. As shown in FIGS. 6 and 7, Sᵢ₁ⱼ₁ and Sᵢ₂ⱼ₂ represent two unit regions at the surface of the first reflector 82, the unit region Sᵢ₁ⱼ₁ is arranged in the central region a, and the unit region Sᵢ₂ⱼ₂ is arranged in the peripheral region b. As shown in FIG. 4, the light reflected by the central region a of the trapezoidal cross section of the first reflector 82 enters the central region of the display panel 64, and the light reflected by the peripheral region b of the trapezoidal cross section of the first reflector 82 enters the peripheral region of the display panel 64.

Optionally, in an embodiment of the present disclosure, as shown in FIGS. 6 and 7, the reflectivity of the reflective thin film corresponding to four corner regions in a peripheral region of the first reflector 82 is smaller than the reflectivity of the reflective thin film corresponding to a central region of the first reflector 82 and regions other than the four corner regions in the peripheral region.

Optionally, in a specific embodiment of the present disclosure, as shown in FIG. 6, X and Y are each 9, i.e., the plurality of unit regions at the surface of the first reflector 82 does not go beyond the region including 9 rows and 9 columns. The central region a of the first reflector 82 includes 3*3 unit regions, the unit region Sᵢ₁ⱼ₁ is arranged in the central region a, the peripheral region b of the first reflector includes the remaining unit regions, and the unit region Sᵢ₂ⱼ₂ is arranged in the peripheral region b. The 9*9 region where the plurality of unit regions at the surface of the first reflector 82 is located is divided into 3*3 unit regions in a row direction and a column direction, so that each reception surface for detecting the brightness of the light reflected by the first reflector 82 receives light from a unit region in the 9 regions of the X*Y region at the surface of the first reflector 82. A position on the reception surface where the light is received is in mirror symmetry with the region at the surface of the first reflector 82, so an upper left region of the first reflector 82 corresponds to an upper right region of the reception surface, a lower left region of the first reflector 82 corresponds to a lower right region of the reception surface, an upper left corner region of the first reflector 82 corresponds to an upper right corner region of the reception surface, and a lower left corner region of the first reflector 82 corresponds to a lower right corner region of the reception surface. It should be appreciated that, the first reflector 82 is of a trapezoidal shape in FIG. 6, so not all the unit regions in the 3*3 unit regions in the Y*Y region are located at the surface of the first reflector 82. Here, the first reflector 82 may also be of any other shape, which will not be particularly defined herein.

The reflective thin films having a same reflectivity are attached to the central region a and the peripheral region b of the first reflector 82, Table 1 shows brightness data at each unit region and the four corner regions in the peripheral region b of the first reflector 82, and Table 2 shows uniformity data. In Table 1, 9 pieces of data at the central region correspond to the brightness of the light reflected by the unit regions at the surface of the first reflector 82 among the 9 regions in the X*Y region, and an order of the 9 pieces of data corresponds to an order of corresponding positions of the reception surface. In Table 1, the data at four corners corresponds to the brightness of the light reflected by the four corner regions in the peripheral region b of the first reflector 82, and an order of the data at the four corners corresponds to an order of corresponding positions of the reception surface. In Table 2, A corresponds to the upper left corner in Table 1, B corresponds to the upper right corner, C corresponds to the lower left corner, and D corresponds to the lower right corner, which is also the same below.

The uniformity for four points is calculated by dividing an average value of the data at the four corners in the 9 pieces of data at the central region by the data in the middle, i.e., (276+276+294+291)/4/458=62%. The uniformity for nine points is calculated by dividing an average of the 9 pieces of data at the central region by the data in the middle, i.e., (276+374+276+318+458+312+294+382+291)/9/458=72%.

TABLE 1

| | | | | |
|---|---|---|---|---|
| 145 | | | | 138 |
| | 276 | 374 | 276 | |
| | 318 | 458 | 312 | |
| | 294 | 382 | 291 | |
| 126 | | | | 135 |

TABLE 2

| | |
|---|---|
| Uniformity for four points | 62% |
| Uniformity for nine points | 72% |
| Brightness for nine points/lm | 739 |
| A | 32% |
| B | 30% |
| C | 28% |
| D | 29% |

The reflectivity of the reflective thin film attached to the central region a at the surface of the first reflector 82 is smaller than the reflectivity of the reflective thin film attached to the peripheral region b at the surface of the first reflector 82, Table 3 shows brightness data at each unit region and the four corner regions in the peripheral region b of the first reflector 82, and Table 4 shows uniformity data. In Table 3, data at the central region correspond to the brightness of the light reflected by the central region a. The regions of the first reflector 82 corresponding to the data in Table 3 are the same as those in Table 1, and thus will not be particularly defined herein. Meanings of the data in Table 4 are the same as those in Table 2, and thus will not be particularly defined herein.

TABLE 3

| | | | | |
|---|---|---|---|---|
| 145 | | | | 138 |
| | 276 | 372 | 276 | |
| | 318 | 437 | 313 | |
| | 294 | 382 | 291 | |
| 126 | | | | 135 |

TABLE 4

| | |
|---|---|
| Uniformity for four points | 65% |
| Uniformity for nine points | 75% |
| Brightness for nine points/lm | 734 |
| A | 33% |
| B | 32% |
| C | 29% |
| D | 31% |

After comparing the data in Table 4 with the data in Table 2, it is found that, in a case that the structure of the projection device is not changed, merely the reflectivity of the reflective thin film attached to the central region a of the first reflector 82 is set to be smaller than the reflectivity of the reflective thin film attached to the peripheral region b of the first reflector 82. At this time, the uniformity for four points is increased by 3%, the uniformity for nine points is increased by 3%, and the uniformity at the four corner regions in the peripheral region b of the first reflector 82 is increased by at least 1% to 2%, so it is able to improve the uniformity of the entire image and the uniformity at the four corner regions. In addition, the uniformity of the entire image and the uniformity at the four corner regions are improved without any change in the structure of the projection device, so it is able to reduce the cost.

Optionally, in an embodiment of the present disclosure, as shown in FIGS. 1, 4 and 5, the projection device further includes a first lens 61, and the first lens 61 is arranged between the light converging assembly 8 and the display panel 64; and light from the light converging assembly 8 is modulated by the first lens 61 into approximately collimated light, and enters the display panel 64.

Optionally, the projection device further includes a transparent member 62, and the transparent member 62 is arranged at a side of the first lens 61 away from the light converging assembly 8. The transparent member 62 is made of glass, and it is used for thermal insulation. Two side surfaces of the transparent member 62 are flat surfaces, so the light is not converged or diffused by the transparent member 62.

Optionally, in an embodiment of the present disclosure, the first lens 61 includes in a convex lens, e.g., a Fresnel lens or an aspherical lens. The first lens 61 is used to focus the light from the light converging assembly 8 to obtain approximately collimated light, and the approximately collimated light passes through the transparent member 62 toward the display panel 64.

Optionally, in an embodiment of the present disclosure, as shown in FIG. 1, the first lens 61 and the transparent member 62 is mounted onto the housing 1 in a snap-fit manner, the first lens 61 is arranged at a side of the first reflector 112 away from the second fan 52, and the transparent member 62 is arranged at a side of the first lens 61 away from the first reflector 61.

Optionally, in an embodiment of the present disclosure, as shown in FIGS. 1, 4 and 5, the projection device further includes a second lens 63, and the second lens 63 is arranged at a side of the display panel 64 away from the first lens 61; and the second lens 63 and the display panel 64 are embedded at two opposite sides of a projection device fixation frame 9 respectively.

Optionally, in an embodiment of the present disclosure, the second lens 63 includes a convex lens, e.g., a Fresnel lens or an aspherical lens.

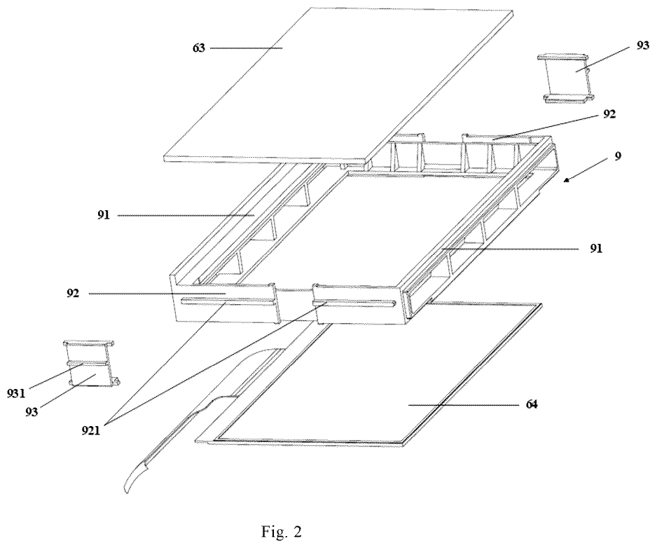

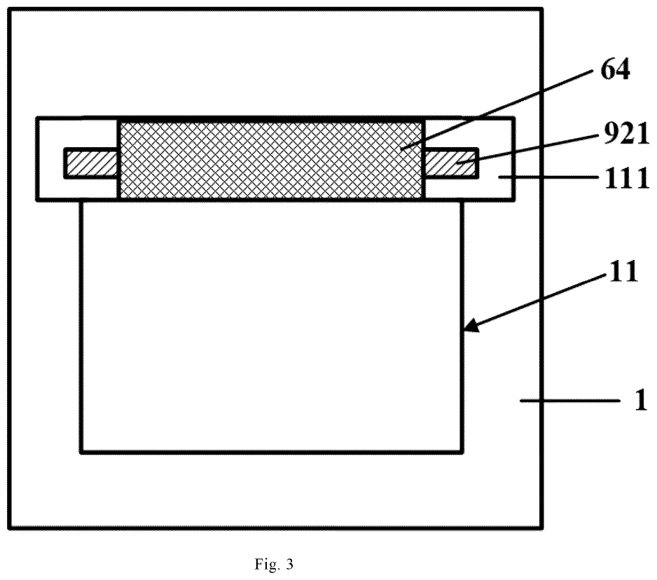

Optionally, in an embodiment of the present disclosure, as shown in FIGS. 1 to 3, the projection device further includes the fixation frame 9 arranged at a side of the transparent member 62 away from the first lens 61. The display panel 64 and the second lens 63 are embedded at two opposite sides of the fixation frame 9 respectively. The second lens 63 is spaced apart from the display panel 64 by a certain distance. The fixation frame 9 includes two pass-through sides 91 arranged opposite to each other, and one of the two pass-through sides 91 faces the first heat dissipator 41. The fixation frame 9 includes two positioning sides 92 arranged opposite to each other, and the two positioning sides 92 are coupled to the two pass-through sides 91. Each positioning side 92 includes a positioning member configured to cooperate with the housing 1 to position the fixation frame 9. The positioning member includes a ridge 921, and the ridge 921 extends in a same direction as the display panel 64. The fixation frame 9 further includes a U-shaped clip 93. The display panel 64, the fixation frame 9 and the second lens 63 are all arranged between two ends of the U-shaped clip 93. The clip 93 clamps at least one positioning side 92 of the fixation frame 9, and it is configured to stop the display panel 64 and the second lens 63 in a thickness direction. The U-shaped clip 93 includes a matched ridge 931 at a position where the positioning side 92 of the fixation frame 9 is clamped. Preferably, the matched ridge 931 and the ridge 921 of the positioning member are continuous, so as to form a continuous, linear sliding rail. As shown in FIG. 3, an inner surface of the housing 1 includes a groove 110, and the ridge 921 cooperates with the groove 111 to position and slide the fixation frame 9. The ridge 921 is configured to slide in the groove 111, so as to pull the display panel 64 out of the housing 1 or push the display panel 64 into the housing 1. It should be appreciated that, the groove 111 may be a part of the housing 1, or a mechanical structure coupled to the housing 1.

Optionally, the first heat dissipator 41 may be detached from the housing 1. The fixation frame 9 is placed into the projection device or taken out of the projection device after the first heat dissipator 4 is detached from the housing 1, so as to facilitate the maintenance of the projection device.

Optionally, in an embodiment of the present disclosure, as shown in FIGS. 1, 4 and 5, the projection device further includes a second reflector 65; the second reflector 65 is arranged at a side of the second lens 63 away from the display panel 64, a central axis of the second lens 63 is parallel to an incident optical path of the second reflector 65, and an emergent optical path of the second reflector 65 is parallel to an optical axis of the lens assembly 3; and the second reflector 65 is detachably mounted on the housing 1 of the projection device.

Optionally, the emergent optical path of the second reflector 65 is on a same line as the optical axis of the lens assembly 3.

Optionally, as shown in FIG. 1, the projection device further includes the second reflector 65, and the second reflector 65 is arranged at a side of the fixation frame 9 away from the transparent member 62. The second reflector 65 is obliquely arranged at a side of the housing 1, and it is detachably mounted on the housing 1.

Optionally, in an embodiment of the present disclosure, the light of the image generated by the display panel 64 is focused by the second lens 63, is reflected by the second reflector 65 and then passes through lens assembly 3, so as to form the projection image on the screen several meters away.

Based on a same inventive concept, the present disclosure further provides in some embodiments a display system, which includes: the above-mentioned display device; and a projection screen configured to receive light from the lens assembly of the projection device to form a projection image.

The display system includes the above-mentioned display device, and a principle and the technical effect thereof may refer to those mentioned hereinabove, which will not be particularly defined herein.

The preset disclosure at least has the following beneficial effects.
1. In the projection device provided in the embodiments of the present disclosure, the reflective thin film covers the plurality of unit regions at the surface of the light converging assembly 8, and the light emitted by the light source assembly 2 passes through the light converging assembly 8, the display panel 64 and the lens assembly 3 sequentially. The light reflected by different unit regions of the light converging assembly 8 enters different unit display regions in the display region of the display panel 64. Through adjusting the reflectivity of the reflective thin film corresponding to different unit regions at the surface of the light converging assembly 8, the light reflected by different unit regions of the light converging assembly 8 has approximately same luminance, so as to enable the light entering different unit display regions of the display panel 64 to have approximately same brightness, thereby to improve the uniformity of the entire image.
2. In the embodiments of the present disclosure, the light reflected by the central region of the light converging assembly 8 enters the central region of the display panel 64, and the light reflected by the peripheral region at the surface of the light converging assembly 8 enters the peripheral region of the display panel 64. Through adjusting the reflectivity of the reflective thin film corresponding to the central region at the surface of the light converging assembly 8 and the reflectivity of the reflective thin film corresponding to the peripheral region at the surface of the light converging assembly 8, the luminance of the light reflected by the central region at the surface of the light converging assembly 8 is close to the luminance of the light reflected by the peripheral region at the surface of the light converging assembly 8, so as to enable the light entering different unit display regions of the display panel 64 to have approximately same brightness, thereby to improve the uniformity of the entire image.

It should be appreciated that, steps, measures and schemes in various operations, methods and processes that have already been discussed in the embodiments of the present disclosure may be replaced, modified, combined or deleted. Further, the other steps, measures and schemes in various operations, methods and processes that have already been discussed in the embodiments of the present disclosure may also be replaced, modified, rearranged, decomposed, combined or deleted. Further, steps, measures and schemes in various operations, methods and processes that are known in the related art and have already been discussed in the embodiments of the present disclosure may also be replaced, modified, rearranged, decomposed, combined or deleted.

In the embodiments of the present disclosure, such words as “center”, “on”, “under”, “front” “back”, “left”, “right” “vertical” “horizontal”, “top”, “bottom”, “inner” and “outer” are used to indicate directions or positions as viewed in the drawings, and they are merely used to facilitate the description in the present disclosure, rather than to indicate or imply that a device or member must be arranged or operated at a specific position, so they cannot be construed as limiting the preset disclosure.

Such words as “first” and “second” may merely be adopted to differentiate different features rather than to implicitly or explicitly indicate any number or importance, i.e., they may be adopted to implicitly or explicitly indicate that there is at least one said feature. Further, such a phrase as “a plurality of” may be adopted to indicate that there are two or more features, unless otherwise specified.

It should be appreciated that, unless otherwise specified, such words as “arrange” and “connect” may have a general meaning, e.g., the word “connect” may refer to fixed connection, removable connection or integral connection, or direct connection or indirect connection via an intermediate component, or communication between two components. The meanings of these words may be understood by a person skilled in the art according to the practical need.

In the above description, the features, structures, materials or characteristics may be combined in any embodiment or embodiments in an appropriate manner.

It should be further appreciated that, although with arrows, the steps in the flow charts may not be necessarily performed in an order indicated by the arrows. Unless otherwise defined, the steps may also be performed in another order according to the practical need in some scenarios. In addition, each of at least a part of, or all of, the steps in the flow charts may include a plurality of sub-steps or stages based on the actual scenario, and a part of, or all of, these sub-steps or stages may be performed at the same time, or at different times. Furthermore, an order of these sub-steps or stages may be configured flexibly according to the practical need, which will not be particularly defined herein.

The above are merely parts of the embodiments of the present disclosure. It should be appreciated that, a person skilled in the art may adopt any other similar measures without departing from the inventive concept of the present disclosure, and these measures also fall within the scope of the present disclosure.

1. A projection device, comprising a light source assembly, a light converging assembly, a display panel and a lens assembly;
wherein light emitted by the light source assembly passes through the light converging assembly, the display panel and the lens assembly sequentially;
a surface of the light converging assembly comprises a plurality of unit regions, and the plurality of unit regions does not go beyond a region of X*Y, where X and Y are both positive integers; a reflective thin film covers the plurality of unit regions at the surface of the light converging assembly; a reflectivity of the reflective thin film corresponding to at least one unit region in the plurality of unit regions is different from a reflectivity of the reflective thin film corresponding to the remaining unit regions; and
light reflected by different unit regions of the light converging assembly enters different unit display regions at a display region of the display panel.

2. The projection device according to claim 1, wherein the surface of the light converging assembly comprises a central region and a peripheral region, and the central region comprises M*N unit regions, where M is a positive integer smaller than X, and N is a positive integer smaller than Y; the peripheral region comprises at least one unit region; and
the reflectivity of the reflective thin film at the central region is smaller than the reflectivity of the reflective thin film at the peripheral region.

3. The projection device according to claim 2, wherein the light reflected by the central region of the light converging assembly enters a central region of the display panel, and the light reflected by the peripheral region of the surface of the light converging assembly enters a peripheral region of the display panel.

4. The projection device according to claim 2, wherein the light converging assembly comprises a reflection cup:
the light source assembly is arranged at an inlet of the reflection cup, and the display panel is arranged at an outlet of the reflection cup; in a direction parallel to the display panel, a size of the outlet of the reflection cup is greater than a size of the inlet of the reflection cup; and
the surface of the light converging assembly comprises an inner wall of the reflection cup.

5. The projection device according to claim 2, wherein the light converging assembly comprises a planoconvex lens and a first reflector;
the light source assembly is arranged at a side of a flat surface of the planoconvex lens, the first reflector is arranged at a convex surface of the planoconvex lens, a central axis of the planoconvex lens is parallel to an incident optical path of the first reflector, and an emergent optical path of the first reflector is perpendicular to the display panel; and
the surface of the light converging assembly comprises a surface of the first reflector.

6. The projection device according to claim 5, wherein in a cross section perpendicular to the display panel, the first reflector is of a trapezoidal shape.

7. The projection device according to claim 6, wherein the reflectivity of the reflective thin film corresponding to four corner regions in a peripheral region of the first reflector is smaller than the reflectivity of the reflective thin film corresponding to a central region of the first reflector and regions other than the four corner regions in the peripheral region.

8. The projection device according to claim 3, further comprising a first lens, wherein the first lens is arranged between the light converging assembly and the display panel; and
light from the light converging assembly is modulated by the first lens into approximately collimated light, and enters the display panel.

9. The projection device according to claim 8, further comprising a second lens, wherein the second lens is arranged at a side of the display panel away from the first lens; and
the second lens and the display panel are embedded at two opposite sides of a projection device fixation frame respectively.

10. The projection device according to claim 9, further comprising a second reflector, wherein the second reflector is arranged at a side of the second lens away from the display panel, a central axis of the second lens is parallel to an incident optical path of the second reflector, and an emergent optical path of the second reflector is parallel to an optical axis of the lens assembly; and
the second reflector is detachably mounted on a housing of the projection device.

11. A display system, comprising: a projection device, wherein the projection device comprises a light source assembly, light converging assembly, a display panel and a lens assembly; and a projection screen configured to receive light from the lens assembly of the projection device to form a projection image,
wherein light emitted by the light source assembly passes through the light converging assembly, the display panel and the lens assembly sequentially;
a surface of the light converging assembly comprises a plurality of unit regions, and the plurality of unit regions does not go beyond a region of X*Y, where X and Y are both positive integers; a reflective thin film covers the plurality of unit regions at the surface of the light converging assembly; a reflectivity of the reflective thin film corresponding to at least one unit region in the plurality of unit regions is different from a reflectivity of the reflective thin film corresponding to the remaining unit regions; and
light reflected by different unit regions of the light converging assembly enters different unit display regions at a display region of the display panel.

12. The projection device according to claim 4, further comprising a first lens, wherein the first lens is arranged between the light converging assembly and the display panel; and
light from the light converging assembly is modulated by the first lens into approximately collimated light, and enters the display panel.

13. The display system according to claim 11, wherein the surface of the light converging assembly comprises a central region and a peripheral region, and the central region comprises M*N unit regions, where M is a positive integer smaller than X, and N is a positive integer smaller than Y; the peripheral region comprises at least one unit region; and
the reflectivity of the reflective thin film at the central region is smaller than the reflectivity of the reflective thin film at the peripheral region.

14. The display system according to claim 13, wherein the light reflected by the central region of the light converging assembly enters a central region of the display panel, and the light reflected by the peripheral region of the surface of the light converging assembly enters a peripheral region of the display panel.

15. The display system according to claim 13, wherein the light converging assembly comprises a reflection cup;
the light source assembly is arranged at an inlet of the reflection cup, and the display panel is arranged at an outlet of the reflection cup; in a direction parallel to the display panel, a size of the outlet of the reflection cup is greater than a size of the inlet of the reflection cup; and
the surface of the light converging assembly comprises an inner wall of the reflection cup.

16. The display system according to claim 13, wherein the light converging assembly comprises a planoconvex lens and a first reflector;
the light source assembly is arranged at a side of a flat surface of the planoconvex lens, the first reflector is arranged at a convex surface of the planoconvex lens, a central axis of the planoconvex lens is parallel to an incident optical path of the first reflector, and an emergent optical path of the first reflector is perpendicular to the display panel; and
the surface of the light converging assembly comprises a surface of the first reflector.

17. The display system according to claim 16, wherein in a cross section perpendicular to the display panel, the first reflector is of a trapezoidal shape.

18. The display system according to claim 17, wherein the reflectivity of the reflective thin film corresponding to four corner regions in a peripheral region of the first reflector is smaller than the reflectivity of the reflective thin film corresponding to a central region of the first reflector and regions other than the four corner regions in the peripheral region.

19. The display system according to claim 14, wherein the projection device further comprises a first lens, wherein the first lens is arranged between the light converging assembly and the display panel; and
light from the light converging assembly is modulated by the first lens into approximately collimated light, and enters the display panel.

20. The display system according to claim 19, wherein the projection device further comprises a second lens, wherein the second lens is arranged at a side of the display panel away from the first lens; and
the second lens and the display panel are embedded at two opposite sides of a projection device fixation frame respectively.
